(19) United States
(12) Patent Application Publication
(10) Pub. No.: US 2024/0085892 A1
(43) Pub. Date: Mar. 14, 2024

(54) AUTOMATIC ADAPTION OF BUSINESS PROCESS ONTOLOGY USING DIGITAL TWINS

(71) Applicant: INTERNATIONAL BUSINESS MACHINES CORPORATION, ARMONK, NY (US)

(72) Inventors: Atul Mene, Morrisville, NC (US); Tushar Agrawal, West Fargo, ND (US); Sarbajit K. Rakshit, Kolkata (IN); Jeremy R. Fox, Georgetown, TX (US)

(21) Appl. No.: 17/931,546

(22) Filed: Sep. 12, 2022

(51) Int. Cl. G05B 19/418

(52) U.S. Cl. CPC G05B 19/41885; G05B 19/41845; G05B 19/4185

(57) ABSTRACT

A method, computer system, and a computer program product for ontology adaptation is provided. The present invention may include constructing a process ontology for an industrial floor. The present invention may include generating a digital twin of the industrial floor. The present invention may include performing a simulation of the digital twin using the process ontology. The present invention may include generating one or more new process ontologies based on inefficiencies identified during the simulation. The present invention may include providing one or more recommendations to a user.

### BACKGROUND

The present invention relates generally to the field of computing, and more particularly to business process ontology.

On any industrial floor there may be one or more different machines each utilized in performing different activities of a workflow. The one or more different machines may communicate with one another in a workflow which may be defined by the business. Over time, the one or more machines may be enhanced by the addition of upgrades and/or new capabilities not previously anticipated under the workflow. These upgrades and/or new capabilities may necessitate changes to the workflow.

The workflow may be illustrated by a process ontology which may be a hierarchal structure illustrating the relationships and activities performed by a plurality of machines comprising an industrial floor. Updating the process ontology may require computer programming and/or testing by a business.

### SUMMARY

Embodiments of the present invention disclose a method, computer system, and a computer program product for ontology adaptation. The present invention may include constructing a process ontology for an industrial floor. The present invention may include generating a digital twin of the industrial floor. The present invention may include performing a simulation of the digital twin using the process ontology. The present invention may include generating one or more new process ontologies based on inefficiencies identified during the simulation. The present invention may include providing one or more recommendations to a user.

In addition to a method, additional embodiments are directed to a computer system and a computer program product for identifying inefficiencies within a business process ontology (e.g., process ontology) and adapting the business process ontology (e.g., process ontology) to current industrial floor capabilities using digital twin simulations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for ontology adaptation according to at least one embodiment.

### DETAILED DESCRIPTION

The following described exemplary embodiments provide a system, method and program product for ontology adaptation. As such, the present embodiment has the capacity to improve the technical field of business process ontology (e.g., process ontology) and digital twin technology by to identifying inefficiencies within a business process ontology (e.g., process ontology) and adapting the business process ontology (e.g., process ontology) to current industrial floor capabilities using digital twin simulations. More specifically, the present invention may include constructing a process ontology for an industrial floor. The present invention may include generating a digital twin of the industrial floor. The present invention may include performing a simulation of the digital twin using the process ontology. The present invention may include generating one or more new process ontologies based on inefficiencies identified during the simulation. The present invention may include providing one or more recommendations to a user.

As described previously, on any industrial floor there may be one or more different machines each utilized in performing different activities of a workflow. The one or more different machines may communicate with one another in a workflow which may be defined by the business. Over time, the one or more machines may be enhanced by the addition of upgrades and/or new capabilities not previously anticipated under the workflow. These upgrades and/or new capabilities may necessitate changes to the workflow.

The workflow may be illustrated by a process ontology which may be a hierarchal structure illustrating the relationships and activities performed by a plurality of machines comprising an industrial floor. Updating the process ontology may require computer programming and/or testing by a business.

Therefore, it may be advantageous to, among other things, construct a process ontology for an industrial floor, generate a digital twin of the industrial floor, perform a simulation of the digital twin using the process ontology, generate one or more new process ontologies based on inefficiencies identified during the simulation, and provide one or more recommendations to the user.

According to at least one embodiment, the present invention may improve ontology construction by identifying one or more inefficiencies within an existing process ontology based on a workflow performance of a digital twin.

According to at least one embodiment, the present invention may improve ontology construction by identifying one or more possible adaptations based on new capabilities, updates, enhancements, maintenance, and/or diminished capacities of the plurality of machines and/or equipment comprising an industrial floor.

According to at least one embodiment, the present invention may improve implementation of new process ontologies and/or recommendations by utilizing an intelligent real estate and facilities management solution which allows a user to simulate the impact of improvements to a workflow prior to implementation.

According to at least one embodiment, the present invention may improve the efficiency of an industrial floor by generating one or more new process ontologies based on inefficiencies identified during a digital twin simulation and providing the user implementation details for adopting the one or more new process ontologies.

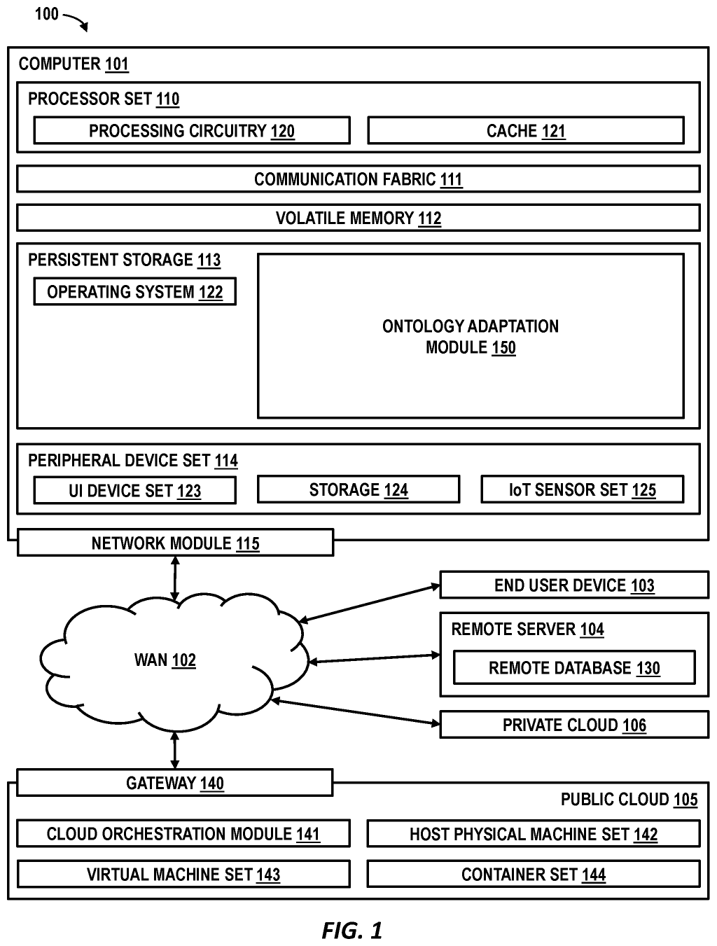

Referring to FIG. 1, Computing environment 100 contains an example of an environment for the execution of at least some of the computer code involved in performing the inventive methods, such as to identify inefficiencies within a business process ontology (e.g., process ontology) and adapt the business process ontology (e.g., process ontology) to current industrial floor capabilities using digital twin simulations ontology adaptation module 150. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

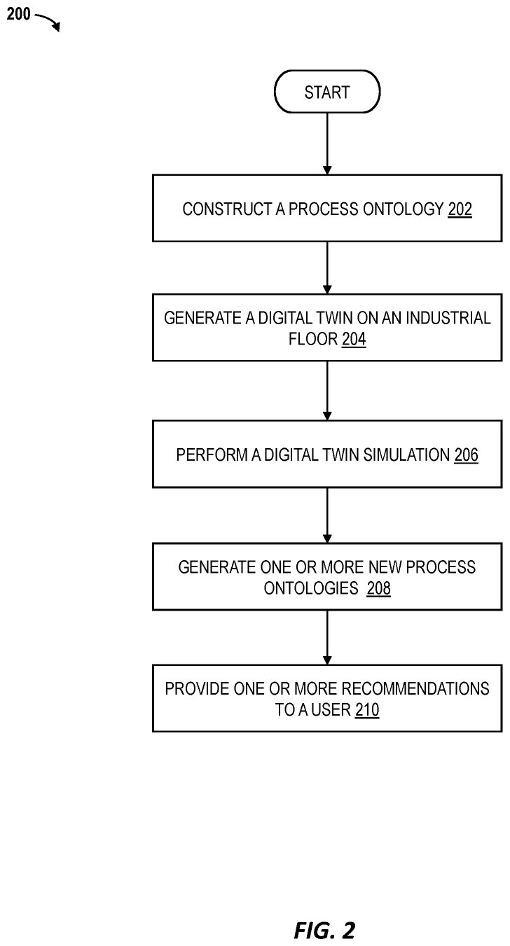

According to the present embodiment, the computer environment 100 may use the ontology adaptation module 150 to identify inefficiencies within a business process ontology (e.g., process ontology) and adapt the business process ontology (e.g., process ontology) to current industrial floor capabilities using digital twin simulations. The ontology adaptation method is explained in more detail below with respect to FIG. 2.

Referring now to FIG. 2, an operational flowchart illustrating the exemplary ontology adaption process 200 used by the ontology adaptation module 150 according to at least one embodiment is depicted.

At 202, the ontology adaptation module 150 constructs a business process ontology (e.g., process ontology) for an industrial floor. The ontology adaptation module 150 may construct the business process ontology (e.g., process ontology) for the industrial floor based on data received and/or accessed. The data received and/or accessed may include, but is not limited to including, metadata received from the equipment, machines, and/or other assets of the industrial floor, documentation received from a user, amongst other data. Documentation received from the user may include, but is not limited to including, procedures, checklists, equipment information, operating instructions, training plans, skills assessments, instructional videos, diagrams, business process event logs, task management plans, types of activities performed on the industrial floor.

The data received and/or accessed by the ontology adaptation module 150 may be stored in the knowledge corpus (e.g., database 130) amongst other metadata associated with the industrial floor. The ontology adaptation module 150 may utilize one or more linguistic analysis techniques in constructing the business process ontology (e.g., process ontology) for the industrial floor based on the data stored in the knowledge corpus (e.g., database 130). The one or more linguistic analysis techniques may include, but are not limited to including, a machine learning model with Natural Language Processing (NLP), Semantic Textual Similarity (STS), Keyword Extraction, amongst other analysis techniques, such as those implemented in IBM Watson® (IBM Watson and all Watson-based trademarks are trademarks or registered trademarks of international Business Machines Corporation in the United States, and/or other countries), IBM Watson® Natural Language Understanding, IBM Watson® Natural Language Classifier, amongst other implementations.

The business process ontology (e.g., process ontology) may be a hierarchal structure which represents knowledge as a set of concepts within a domain, and the relationships between those concepts, which may be used to model a domain and support reasoning about concepts and/or processes. The business process ontology (e.g., process ontology) of the industrial floor may be utilized by the ontology adaptation module 150 in formalizing business rules and/or processes derived from the data received and/or accessed. The business process ontology (e.g., process ontology) may include many different aspects, such as, but not limited to, activities, ordering, duration and/or wait times, acting resources and/or roles, business objectives, associated values, states, milestones, decisions, and/or process outcomes, amongst other aspects. Business processes may change over time due to dynamic business requirements. As will be explained in more detail below, the industrial floor may be comprised of a plurality of machines with each of the machines performing different activities in a workflow, the workflow corresponding to the business process ontology (e.g., process ontology). As the capabilities and/or capacities of the machines change and/or new capabilities and/or updates may be added the business process ontology (e.g., process ontology) may require updates. The ontology adaptation module 150 may store the business process ontology (e.g., process ontology) in the knowledge corpus (e.g., database 130).

At 204, the ontology adaptation module 150 generates a digital twin of the industrial floor. A digital twin may be a virtual representation of an object or system which may be updated using real-time data, and may be utilized in at least, simulations, machine learning, and/or reasoning in aiding informed decision making. As will be described in more detail below, the ontology adaptation module 150 may utilize the digital twin in making informed business process ontology (e.g., process ontology) adaptations based on one or more simulations.

The ontology adaptation module 150 may generate the digital twin of the industrial floor based on at least the data accessed and/or received at step 202 for the industrial floor. The digital twin may represent the corresponding capabilities, capacities, Key Performance Indicators (KPIs), and/or updates of the plurality of machines comprising the industrial floor. The digital twin of the industrial floor may represent the current state of each of the plurality of machines and/or equipment comprising the industrial floor. The ontology adaptation module 150 may continuously receive and/or access the data described in step 202 and/or additional data such that the ontology adaptation module may update the digital twin of the industrial floor in real time to correspond to the current state of each of the plurality of machines and/or equipment comprising the industrial floor. The ontology adaptation module 150 may store the digital twin and/or any updates to the digital twin in the knowledge corpus (e.g., database 130) such that a user may access previous digital representations of the industrial floor using the EUD 103. As will be described in more detail below, the ontology adaptation module may also incorporate updates, new capabilities, enhancements, maintenance, and/or other upgrades into the digital twin.

At 206, the ontology adaptation module 150 performs a digital twin simulation of the business process ontology (e.g., process ontology) utilizing the digital twin of the industrial floor. The ontology adaptation module 150 may utilize one or more machine learning models and/or one or more simulation methods in performing the digital twin simulation of the business process ontology (e.g., process ontology) utilizing the digital twin of the industrial floor.

The one or more machine learning models may include, but are not limited to including, Convolutional Neural Networks (CNNs), Artificial Neural Networks (ANNs), Support Vector Machine (SVM), K-Nearest Neighbors (KNN), Naïve Bayes, and/or a hybrid model. The hybrid model may be trained to combine the predictions of two or more machine learning models. The one or more simulation models may include, but are not limited to including, a Monte Carlo simulation process, agent based simulation model, discrete event simulation model, and/or a system dynamic simulation model, amongst other simulation methods. The ontology adaptation module 150 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods.

The ontology adaptation module 150 may perform the digital twin simulation of the business process ontology (e.g., process ontology) based on a workflow. The ontology adaptation module may derive the workflow using the data received and/or accessed at step 202 with the one or more linguistic analysis techniques and/or receive the workflow directly from the user on the EUD 103. The workflow may be a specific business process, safety procedure, evacuation procedure, activity, and/or other process performed on the industrial floor. The ontology adaptation module may extract one or more concepts from the workflow and identify how the workflow will be executed according to the business process ontology (e.g., process ontology). Accordingly, the ontology adaptation module may identify one or more inefficiencies within the business process ontology (e.g., process ontology) and/or the plurality of machines on the industrial floor. The ontology adaptation module 150 may identify the one or more inefficiencies by comparing the business process ontology (e.g., process ontology) with the performance of the digital twin for the workflow and/or measuring one or more performance metrics. The one or more performance metrics may include, but are not limited to including, bottlenecks in the workflow, long durations and/or wait times in activity executions, lagging KPIs, process outcomes, possible replacement machines and/or equipment, consumption, output produced (e.g., throughput), amongst other performance metrics. The ontology adaptation module 150 may also identify inefficiencies using digital twins and/or business process ontologies (e.g., process ontologies) stored in the knowledge corpus (e.g., database 130).

The ontology adaptation module 150 may identify one or more possible adaptations based on new capabilities, updates, enhancements, maintenance, the addition of new machines and/or equipment, and/or diminished capacities of the plurality of machines and/or other equipment comprising the industrial floor. As will be explained in more detail below, the ontology adaptation module 150 may generate one or more new business process ontologies (e.g., new process ontologies) based on the inefficiencies identified within the business process ontology (e.g., process ontology) determined based on the performance of the digital twin simulation.

At 208, the ontology adaptation module 150 generates one or more new business process ontologies based on the inefficiencies identified within the business process ontology (e.g., process ontology). The one or more new business process ontologies (e.g., new process ontologies) may include, but are not limited to including. removal of one or more of the plurality of machines, rearranging activity ordering, changing an acting resource and/or role, amongst other possible adaptations.

The ontology adaptation module 150 may generate the one or more new business process ontologies utilizing the one or more linguistic analysis techniques described above with respect to step 202. The ontology adaptation module 150 may utilize the one or more linguistic analysis techniques to describe the relationships between the machines and/or equipment of the industrial floor, the acting resources and/or roles of the machines and/or equipment, the ordering of processes, amongst other details describing the concepts within the domain.

The ontology adaptation module 150 may simulate each of the one or more new business process ontologies (e.g., new process ontologies) using at least the one or more machine learning models and/or one or more simulation methods described at step 206. The ontology adaptation module 150 may rank the one or more new business process ontologies (e.g., new process ontologies) based on their respective performances in the digital twin simulation. The ontology adaptation module 150 may present the rankings and/or the hierarchal structure for each of the one or more new business process ontologies (e.g., new process ontologies) to the user on the EUD 103. The ontology adaptation module 150 may rank the one or more new business process ontologies (e.g., new process ontologies) based on a comparison of each new business process ontology (e.g., process ontology) with the business process ontology (e.g., process ontology) constructed for the industrial floor at step 202. The ontology adaptation module may compare performance metrics, such as, but not limited to, KPIs, durations and/or wait times in activity execution, process outcomes, amongst other performance metrics in ranking the one or more new business process ontologies (e.g., new process ontologies).

In an embodiment, the user may also input one or more potential changes and/or potential updates to the industrial floor using the EUD 103. In this embodiment, the ontology adaptation module 150 may generate one or more new business process ontologies (e.g., new process ontologies) which incorporate the one or more potential changes and/or potential updates. For example, the user may be considering the replacement of an old machine with a new machine. The ontology adaptation module 150 may remove the old machine from the digital twin and replace it with a digital representation of the new machine based on information provided from the user and/or data accessed from a third party, such as the manufacturer's website. The ontology adaptation module 150 may generate one or more new business process ontologies and provide the user with the corresponding data of the performance simulations. In this embodiment, the user may be able to both evaluate the addition of the new machine, how best to incorporate the new machine, and/or quantify workflow improvement the new machine provides.

At 210, the ontology adaptation module 150 provides one or more recommendations to the user. The one or more recommendations may be provided by the ontology adaptation module 150 to the user on the EUD 103. The one or more recommendations may include, but are not limited to including, the one or more new business process ontologies (e.g., new process ontologies) generated at step 208, details on implementing the one or more new business process ontologies (e.g., new process ontologies), amongst other recommendations.

The ontology adaptation module 150 may utilize an intelligent real estate and facilities management solution, such as, but not limited to, IBM TRIRIGA® (IBM TRIRIGA® and all IBM TRIRIGA-based trademarks are trademarks or registered trademarks of International Business Machines Corporation in the United States, and/or other countries), in providing one or more recommendations to the user based on the simulation of the digital twin and/or the performance of the one or more new business process ontologies (e.g., new process ontologies). The intelligent real estate and facilities management solution may be displayed by the ontology adaptation module 150 to the user on the EUD 103.

The ontology adaptation module 150 may also utilize the intelligent real estate and facilities management solution in displaying the one or more new business process ontologies (e.g., new process ontologies), as well as the implementation steps which may enable the user to adopt the new business process ontologies (e.g., new process ontologies) for the industrial floor. The implementations steps may include, but are not limited to including, the rearrangement of the machines and/or equipment comprising the industrial floor, structural recommendations, combinations of different machines, addition of new machines and/or equipment based on the capabilities of the plurality of machines and/or equipment currently comprising the industrial floor, activity ordering, additional capabilities which may be installed on existing machines and/or equipment, amongst other implementation steps. The ontology adaptation module 150 may enable the user on the EUD 103 to utilize the intelligent real estate and facilities management solution such that the user may be able to implement one or more of the recommendations and/or parts of the new business process ontologies (e.g., new process ontologies) and simulate the performance of the industrial floor for different workflows.

The ontology adaptation module 150 may present the user with projections of wait times, bottlenecks, amongst other metrics based on recommendations and/or the new business process ontology selected by the user. The ontology adaptation module 150 may additionally be able to project costs of implementation for each of the one or more recommendations selected by the user which may enable the user to implement the new business process ontology while considering budgetary constraints.

The ontology adaptation module 150 may continue to monitor the industrial floor and the data accessed and/or received based on workflow. The ontology adaptation module 150 may store the data accessed and/or received based on workflow in the knowledge corpus (e.g., database 130). The ontology adaptation module 150 may utilize the recommendations and/or new business process ontologies (e.g., new process ontologies) implemented by the user as well as the data accessed and/or received based on workflow to improve the one or more recommendations and/or provide new recommendations based on at least updates, new capabilities, enhancements, and/or maintenance to the user.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for ontology adaptation, the method comprising:
constructing a process ontology for an industrial floor;
generating a digital twin of the industrial floor;
performing a simulation of the digital twin using the process ontology;
generating one or more new process ontologies based on inefficiencies identified during the simulation; and
providing one or more recommendations to a user.

2. The method of claim 1, wherein the simulation of the digital twin using the process ontology is simulated for a workflow identified by the user.

3. The method of claim 1, wherein the simulation of the digital twin is performed utilizing one or more machine learning models.

4. The method of claim 1, wherein the process ontology for the industrial floor is constructed utilizing one or more linguistic analysis techniques based on data received for the industrial floor.

5. The method of claim 1, wherein the one or more recommendations are provided to the user on an end user device using an intelligent real estate and facilities management solution.

6. The method of claim 1, wherein identifying the inefficiencies during the simulation further comprises:
comparing the process ontology with the performance in the simulation of the digital twin and measuring one or more performance metrics.

7. The method of claim 1, wherein the one or more recommendations provided to the user includes implementation details of the one or more new process ontologies.

8. A computer system for ontology adaptation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
constructing a process ontology for an industrial floor;
generating a digital twin of the industrial floor;
performing a simulation of the digital twin using the process ontology;
generating one or more new process ontologies based on inefficiencies identified during the simulation; and
providing one or more recommendations to a user.

9. The computer system of claim 8, wherein the simulation of the digital twin using the process ontology is simulated for a workflow identified by the user.

10. The computer system of claim 8, wherein the simulation of the digital twin is performed utilizing one or more machine learning models.

11. The computer system of claim 8, wherein the process ontology for the industrial floor is constructed utilizing one or more linguistic analysis techniques based on data received for the industrial floor.

12. The computer system of claim 8, wherein the one or more recommendations are provided to the user on an end user device using an intelligent real estate and facilities management solution.

13. The computer system of claim 8, wherein identifying the inefficiencies during the simulation further comprises:
comparing the process ontology with the performance in the simulation of the digital twin and measuring one or more performance metrics.

14. The computer system of claim 8, wherein the one or more recommendations provided to the user includes implementation details of the one or more new process ontologies.

15. A computer program product for ontology adaptation, comprising:
one or more non-transitory computer-readable storage media and program instructions stored on at least one of the one or more tangible storage media, the program instructions executable by a processor to cause the processor to perform a method comprising:
constructing a process ontology for an industrial floor;
generating a digital twin of the industrial floor;
performing a simulation of the digital twin using the process ontology;
generating one or more new process ontologies based on inefficiencies identified during the simulation; and
providing one or more recommendations to a user.

16. The computer program product of claim 15, wherein the simulation of the digital twin using the process ontology is simulated for a workflow identified by the user.

17. The computer program product of claim 15, wherein the simulation of the digital twin is performed utilizing one or more machine learning models.

18. The computer program product of claim 15, wherein the process ontology for the industrial floor is constructed utilizing one or more linguistic analysis techniques based on data received for the industrial floor.

19. The computer program product of claim 15, wherein the one or more recommendations are provided to the user on an end user device using an intelligent real estate and facilities management solution.

20. The computer program product of claim 15, wherein identifying the inefficiencies during the simulation further comprises:
comparing the process ontology with the performance in the simulation of the digital twin and measuring one or more performance metrics.
